(19) United States
(12) Patent Application Publication
(10) Pub. No.: US 2018/0101907 A1
(43) Pub. Date: Apr. 12, 2018

(54) Methods and Systems for Cluster-Based Historical Data

(71) Applicant: CAPITAL ONE SERVICES, LLC, MCLEAN, VA (US)

(72) Inventors: Mark Yamashita, Toronto (CA); Animesh Dwivedi, Toronto (CA); Devashish Khatwani, Toronto (CA); Yuheng Helen Jiang, Toronto (CA); Qirui Yang, North York (CA)

(73) Assignee: Capital One Services, LLC

(21) Appl. No.: 15/701,798

(22) Filed: Sep. 12, 2017

Related U.S. Application Data
(63) Continuation of application No. 15/700,782, filed on Sep. 11, 2017.
(60) Provisional application No. 62/405,204, filed on Oct. 6, 2016.

(51) Int. Cl. G06Q 40/06; H04L 29/08; G06F 17/30; G06Q 30/02

(52) U.S. Cl. CPC G06Q 40/06; H04L 67/22; H04L 67/306; G06Q 30/0201; G06F 17/30705

(57) ABSTRACT

Methods and systems for cluster-based historical data are disclosed. In one embodiment, a method includes accessing historical data associated with a plurality of users and, based on the historical data, constructing a plurality of clusters. Constructing each cluster involves selecting a subset of comparable users and including in the cluster historical data associated with the subset of comparable users. The operations further include storing the cluster, receiving, from a new user, a request for a recommendation, and accessing historical data associated with the new user. The operations further include, based on the historical data associated with the new user, selecting a cluster for which the subset of comparable users is comparable to the new user, based on the selected cluster, determining a recommendation, and providing the recommendation to the new user.

### CROSS-REFERENCE TO RELATED APPLICATIONS

This application claims priority to U.S. patent application Ser. No. 15/700,782 filed Sep. 11, 2017, which in turn claims priority to U.S. Provisional Patent Application Ser. No. 62/405,204, filed Oct. 6, 2016, the contents of which are hereby incorporated in their entirety.

### BACKGROUND

In some cases, historical data can provide useful insights into how future behavior will affect outcomes. For example, historical data indicating what financial actions users have taken over a time period, along with historical data indicating changes in the users' credit scores during the time period, can provide useful insights into how future financial actions will affect credit scores.

Accordingly, historical data may be used to generate recommendations for future behavior that can help a user achieve a desired outcome. Historical data indicating what financial actions users have made over a time period, along with historical data indicating changes in the users' credit scores during the time period, for example, can be used to generate recommendations for how a user can improve a credit score. For instance, it may be recommended that a user hoping to improve a credit score take the same financial actions taken by users whose credit scores improved, as indicated by the historical data. Similarly, it may be recommended that the user hoping to improve a credit score avoid the financial actions taken by users whose credit scores declined, as indicated by the historical data.

Historical data is typically maintained in data storage, such as at a database or in cloud-based storage accessible over a network, such as the Internet. In typical data storage, historical data includes, for each of a number of users, an identity of the user, one or more attributes of the user, and a time period during which the user exhibited the attributes. Historical data may also include financial choices made by the user made over a time period and changes in the users' credit score during the time period.

In typical data storage, historical data is stored in bulk; that is, no grouping or categorization of the data is provided. Thus, recommendations based on typical stored historical data cannot be generated and tailored on the basis of the user, attributes, and/or time period described by the historical data. As a result, recommendations generated based on typical stored historical data can provide only limited insights into how future behavior will affect outcomes.

### SUMMARY

The disclosed embodiments describe cluster-based historical data.

In one embodiment, a server is disclosed that includes a memory storing instruction; and a processor configured to execute the instructions to perform operations. The operations include accessing historical data associated with a plurality of users and, based on the historical data, constructing a plurality of clusters. Constructing each cluster involves selecting a subset of comparable users and including in the cluster historical data associated with the subset of comparable users. The operations further include storing the cluster, receiving, from a new user, a request for a recommendation, and accessing historical data associated with the new user. The operations further include, based on the historical data associated with the new user, selecting a cluster for which the subset of comparable users is comparable to the new user, based on the selected cluster, determining a recommendation, and providing the recommendation to the new user.

In another embodiment, a method is disclosed. The method includes accessing historical data associated with a plurality of users and, based on the historical data, constructing a plurality of clusters. Constructing each cluster involves selecting a subset of comparable users and including in the cluster historical data associated with the subset of comparable users. The operations further include storing the cluster, receiving, from a new user, a request for a recommendation, and accessing historical data associated with the new user. The operations further include, based on the historical data associated with the new user, selecting a cluster for which the subset of comparable users is comparable to the new user, based on the selected cluster, determining a recommendation, and providing the recommendation to the new user.

In another embodiment, a server is disclosed that includes a memory storing instructions and a processor configured to execute the instructions to perform operations. The operations include accessing historical data associated with a plurality of users; based on the historical data, constructing a plurality of clusters, the clusters including historical data associated with a subset of the users; and storing the clusters. The operations further include, for each cluster, identifying users in the subset of users, based on the historical data associated with the subset of users, that are historically improving users, and, for each historically improving user, determining, based on the historical data associated with the historically improving user, a positive predictive attribute indicative of historical improvement. The operations further include receiving, from a new user, a request for a recommendation; accessing historical data associated with the new user; based on the historical data associated with the new user, selecting a cluster; determining the recommendation based on the positive predictive attribute for the selected cluster; and providing the recommendation to the new user.

In another aspect, a method is disclosed. The method includes accessing historical data associated with a plurality of users; based on the historical data, constructing a plurality of clusters, the clusters including historical data associated with a subset of the users; and storing the clusters. The method further includes, for each cluster, identifying users in the subset of users, based on the historical data associated with the subset of users, that are historically improving users, and, for each historically improving user, determining, based on the historical data associated with the historically improving user, a positive predictive attribute indicative of historical improvement. The method further includes receiving, from a new user, a request for a recommendation; accessing historical data associated with the new user; based on the historical data associated with the new user, selecting a cluster; determining the recommendation based on the positive predictive attribute for the selected cluster; and providing the recommendation to the new user.

Aspects of the disclosed embodiments may include non-transitory, tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram of an exemplary system, consistent with disclosed embodiments.

FIG. 2 is a block diagram of an exemplary cluster server, consistent with disclosed embodiments.

FIG. 3 is a block diagram of an exemplary computing device, consistent with disclosed embodiments.

FIG. 4 is a flowchart of an exemplary cluster process, consistent with disclosed embodiments.

FIGS. 5A-5C illustrate exemplary clustering of historical data, consistent with disclosed embodiments.

FIGS. 6A-6C illustrate exemplary recommendations provided to a new user, consistent with disclosed embodiments.

### DETAILED DESCRIPTION

Reference will now be made in detail to the disclosed embodiments, examples of which are illustrated in the accompanying drawings.

The disclosed systems, methods, and media describe cluster-based based historical data. Historical data may include data describing a number of users and, for each user, a number of attributes exhibited by the user during a period of time. Historical data may also include financial actions taken by users over a time period and changes to the users' credit score during the time period.

A “cluster” may be defined as a portion of historical data describing a subset of users included in the historical data, where the subset of users is defined on the basis of the user, attributes, and/or time period described by the historical data. That is, a cluster may include historical data describing only a subset of users exhibiting a certain attribute or attributes during a time period. For example, for historical data indicating financial actions taken by users over a time period and changes in the users' credit scores during the time period, a cluster may include historical data relating to only a subset of users who have taken certain financial actions during a certain time period. Historical data relating to other users who have not taken these financial actions during this time period may not be included in the cluster.

Historical data may be organized into any number of clusters. In some cases, historical data relating to a given user may be included in only a single cluster. Alternatively, historical data relating to a given user may be included in two or more clusters. Historical data organized into clusters may be stored in data storage.

The cluster-based historical data may be used to generate recommendations for future behavior that can help a user achieve a desired outcome. A recommendation may be defined as data indicating attributes that will assist a user in achieving a desired outcome and/or attributes that will hinder a user in achieving a desired outcome. For instance, a recommendation based on historical data indicating what financial actions users have taken in the past and historical data indicating changes in the users' credit scores, may indicate financial actions that will assist a user in improving a credit score and/or attributes that will hinder a user in improving a credit score.

Unlike recommendations based on historical data in typical data storage, recommendations generated based on cluster-based historical data may be tailored on the basis of the user, attributes, and/or time period described by the historical data. For example, recommendations generated based on cluster-based historical data may identify clusters describing a subset of users exhibiting a certain attribute or attributes during a time period and generate the recommendation based only on the subset of users. As a result, recommendations generated based on cluster-based historical data can provide improved insights into how future behavior will affect outcomes.

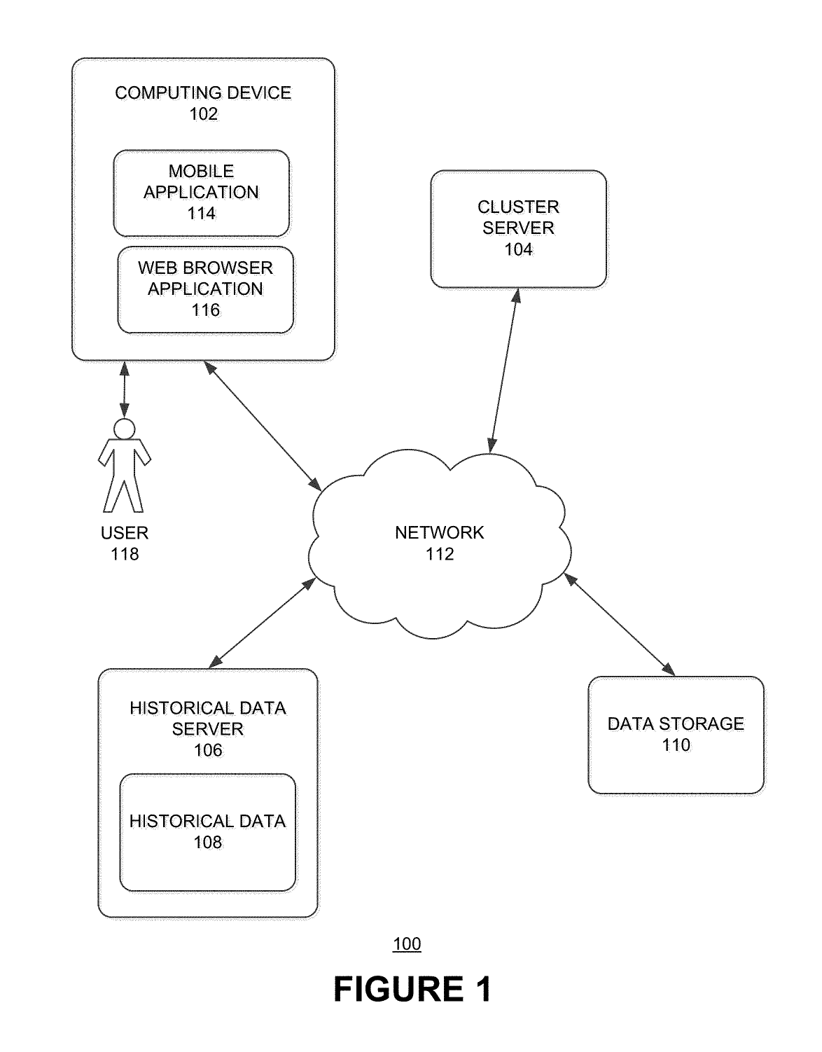

FIG. 1 is a block diagram of an exemplary system 100, consistent with disclosed embodiments. System 100 may be configured for performing a cluster process consistent with disclosed embodiments.

As shown, system 100 may include a computing device 102, a cluster server 104, a historical data server 106 that includes historical data 108, and data storage 110. As shown, computing device 102, cluster server 104, historical data server 106, and data storage 110 may be communicatively coupled by a network 112.

While only one computing device 102, cluster server 104, historical data server 106, data storage 110, and network 112 are shown, it will be understood that system 100 may include more than one of any of these components. More generally, the components and arrangement of the components included in system 100 may vary. Thus, system 100 may include other components that perform or assist in the performance of one or more processes consistent with the disclosed embodiments.

Computing device 102 may be one or more computing devices configured to perform operations consistent with requesting a recommendation from cluster server 104. The recommendation may be guidance, directions, or advice (or information in support of such guidance, directions, or advice) for achieving a goal. For example, the recommendation may be a recommendation for improving a credit score. As another example, the recommendation may be a recommendation for creating or managing a stock portfolio. More generally, the recommendation may be any direction of future actions of an individual based on historical actions of more than one individual. Computing device 102 may be further configured to receive the recommendation from cluster server 104.

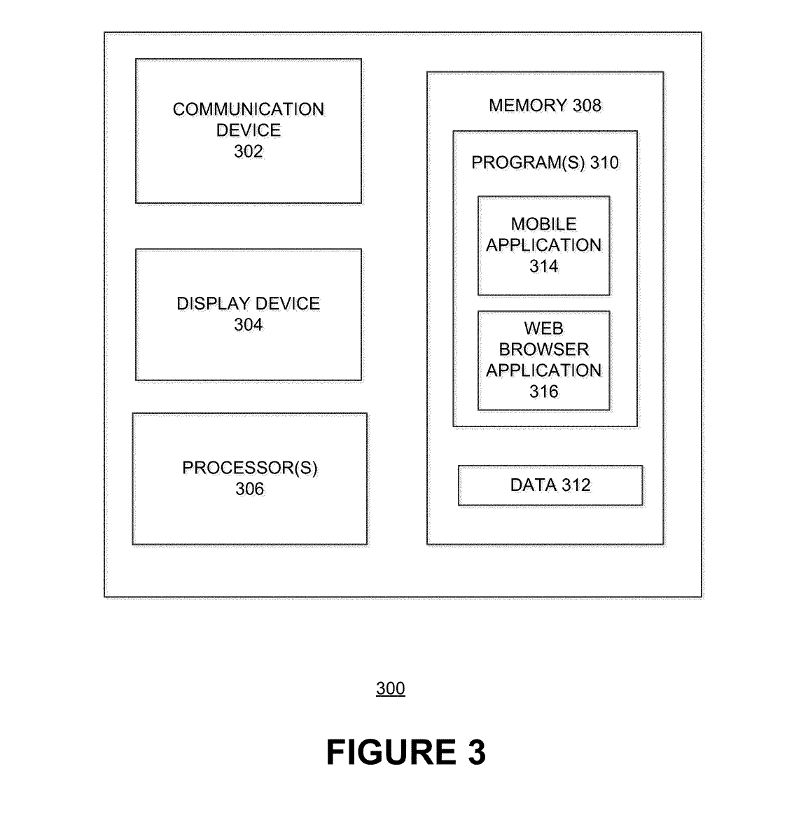

In some embodiments, computing device 102 may include a mobile application 114 and/or a web browser application 116. Mobile application 114 may be one or more software applications configured to perform operations consistent with communicating with cluster server 104. Web browser application 116 may be one or more software applications configured to perform operations consistent with providing web pages, such as web pages associated with cluster server 104, and communicating with cluster server 104. Computing device 102 may be associated with a user 118. User 118 may be an individual, an entity, and/or an account associated with the individual or entity. For example, a user may be an individual or a financial account associated with the individual. As another example, a user may be a corporation or a representative of the corporation. User 118 may request and/or receive the recommendation from cluster server 104 through mobile application 114 and/or through a web page provided through web browser application 116. Computing device 102 is further described below in connection with FIG. 3.

Cluster server 104 may be one or more computing devices configured to perform operations consistent with generating clusters based on historical data 108. In some embodiments, cluster server 104 may be configured to access historical data 108 at historical data server 106. Alternatively or additionally, in some embodiments some or all of historical data 108 may be maintained elsewhere, such as at cluster server 104, in data storage 110, and/or in another entity in network 112 and/or system 100. In some embodiments, cluster server 104 may be further configured to generate, based on historical data 108, a number of clusters. In some embodiments, cluster server 104 may store the generated clusters in data storage 110. Alternatively or additionally, in some embodiments some or all of the generated clusters may be stored elsewhere, such as at cluster server 104, at historical data server 106, and/or in another entity in network 112 and/or system 100.

Cluster server 104 may be further configured to perform operations consistent with providing a recommendation to computing device 102. In some embodiments, cluster server 104 may receive a request for the recommendation from computing device 102. Cluster server 104 may be configured to select a cluster for user 118 and, based on the selected cluster, determine the recommendation. Cluster server 104 may provide the recommendation to computing device 102.

Historical data server 106 may be one or more computing devices configured to maintain historical data 108. Historical data 108 may include data associated with a number of users and, for each user, a number of attributes exhibited by the user during a period of time. Historical data 108 may also include, for each user, financial actions the user has taken over a time period and changes to the user's credit score during the time period.

Each user may be an individual, an entity, and/or an account associated with the individual or entity. For example, a user may be an individual, a financial account associated with the individual, or a corporation or a representative of the corporation. Historical data 108 may also include data describing, for each user, a number of attributes exhibited by the user during a period of time such as, for example, financial actions taken by the user over a time period or changes to the user's credit score over the time period.

In some embodiments, historical data server 106 may aggregate historical data from one or more sources, such as one or more servers in network 112 and/or system 100. Alternatively or additionally, historical data server 106 may be included in and/or otherwise associated with one or more such sources. In some embodiments, historical server 106 may aggregate data from, may be included in, and/or may be otherwise associated with a financial service entity that provides, maintains, manages, or otherwise offers financial services. For example, the financial service entity may be a bank, credit card issuer, or any other type of financial service entity that generates, provides, manages, and/or maintains user accounts for one or more customers. In some embodiments, user accounts may include, for example, credit card accounts, loan accounts, checking accounts, savings accounts, reward or loyalty program accounts, and/or any other type of financial service account. As another example, the financial service entity may be a credit agency or other type of financial service entity that generates, manages, and/or maintains credit ratings and/or credit reports for customers. Historical data server 106 may aggregate data from, may be included in, and/or may be otherwise associated with other entities in network 112 and/or system 100 as well. While historical data server 106 is shown separately, in some embodiments historical data server 106 may be included in and/or otherwise associated with cluster server 104, data storage 110, and/or another entity in network 112 and/or system 100.

Data storage 110 may include one or more memory devices that store information and are accessed and/or managed through cluster server 104. By way of example, data storage 110 may include one or more database(s), such as Oracle™ databases, Sybase™ databases, or other relational databases or non-relational databases, such as Hadoop sequence files, HBase, or Cassandra. Such database(s) may include computing components (e.g., database management system, database server, etc.) configured to receive and process requests for data stored in memory devices of the database(s) and to provide data from the database(s). Alternatively or additionally, data storage 110 may include cloud-based storage accessible by cluster server 104 over network 112 and/or another network. Clusters generated at cluster server 104 may be stored in data storage 110 as, for example, an instance or an object, such as a Java object, accessible by cluster server 104. While data storage 110 is shown separately, in some embodiments data storage 110 may be included in and/or otherwise associated with cluster server 104, historical data server 106, and/or another entity in network 112 and/or system 100.

Network 112 may be any type of network configured to provide communication between components of system 100. For example, network 112 may be any type of network (including infrastructure) that provides communications, exchanges information, and/or facilitates the exchange of information, such as the Internet, a Local Area Network, near field communication (NFC), optical code scanner, or other suitable connection(s) that enables the sending and receiving of information between the components of system 100. In other embodiments, one or more components of system 100 may communicate directly through a dedicated communication link(s).

It is to be understood that the configuration and boundaries of the functional building blocks of system 100 have been defined herein for the convenience of the description. Alternative boundaries may be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

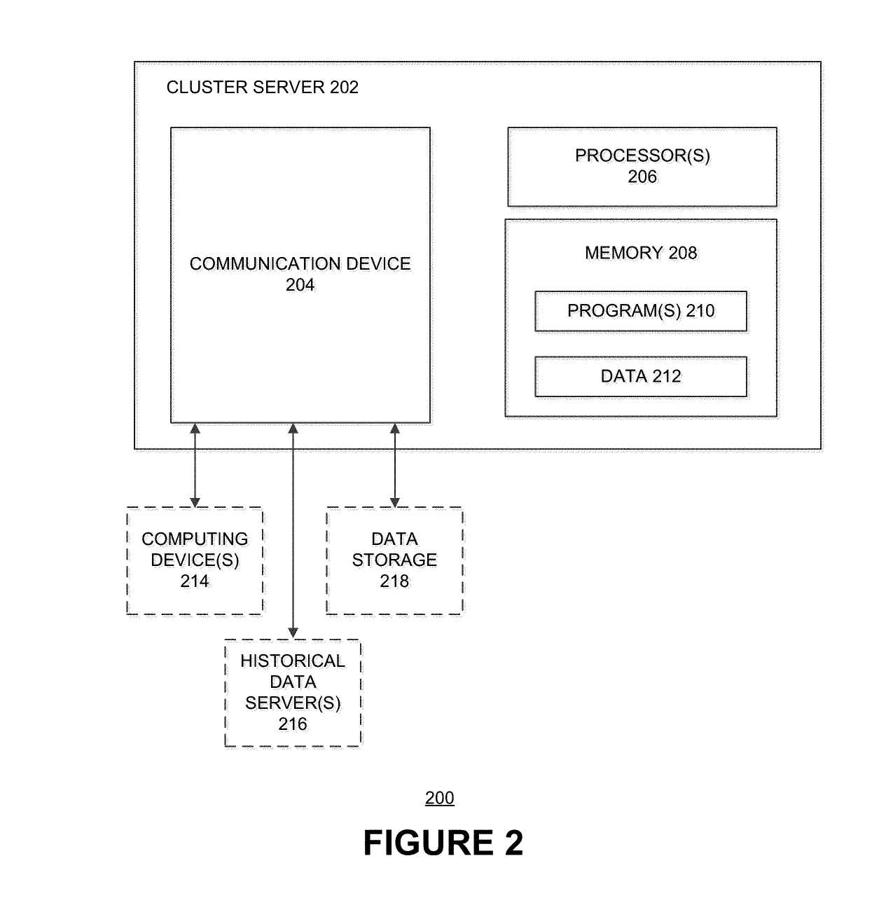

FIG. 2 is a block diagram of an exemplary cluster system 200, consistent with disclosed embodiments. As shown, cluster system 200 may include cluster server 202, which may include a communication device 204, one or more processor(s) 206, and memory 208 including one or more program(s) 210 and data 212.

Cluster server 202 may take the form of a server, general purpose computer, mainframe computer, or any combination of these components. Other implementations consistent with disclosed embodiments are possible as well.

Communication device 204 may be configured to communicate with one or more entities. For example, in some embodiments, communication device 204 may be configured to communicate with one or more computing device(s) 214, such as computing device 102 described above. In some embodiments, communication device 204 may be configured to communicate with the computing device(s) 214 through a mobile application, such as mobile application 114 described above, and/or through a web page provided by a web browser application, such as web browser application 116 described above. In particular, in some embodiments, cluster server 202 may be configured to receive from one or more computing device(s) 214 a request for a recommendation and to provide the recommendation to the computing device(s) 214. Communication device 204 may be configured to communicate with the computing device(s) 214 in other manners as well.

Communication device 204 may be further configured to communicate with one or more historical data server(s) 216, such as historical data server 106 described above. In some embodiments, cluster server 202 may be configured to access historical data maintained at historical data server(s) 216. Communication device 204 may be configured to communicate with the historical data server(s) 216 in other manners as well.

Communication device 204 may be still further configured to communicate with data storage 218, such as data storage 110 described above. In some embodiments, cluster server 202 may be configured to generate clusters based on historical data accessed at historical data server(s) 216 and store the generated clusters in data storage 218. Communication device 204 may be configured to communicate with data storage 218 in other manners as well.

Communication device 204 may also be configured to communicate with other components. In general, communication device 204 may be configured to provide communication over a network, such as network 112 described above. To this end, communication device 204 may include, for example, one or more digital and/or analog devices that allow cluster server 200 to communicate with and/or detect other components, such as a network controller and/or wireless adaptor for communicating over the Internet. Other implementations consistent with disclosed embodiments are possible as well.

Processor(s) 206 may include one or more known processing devices, such as a microprocessor from the Core™, Pentium™ or Xeon™ family manufactured by Intel™, the Turion™ family manufactured by AMD™, the “Ax” or “Sx” family manufactured by Apple™, or any of various processors manufactured by Sun Microsystems, for example. The disclosed embodiments are not limited to any type of processor(s) otherwise configured to meet the computing demands required of different components of cluster system 200.

Memory 208 may include one or more storage devices configured to store instructions used by processor(s) 206 to perform functions related to disclosed embodiments. For example, memory 208 may be configured with one or more software instructions, such as program(s) 210, that may perform one or more operations when executed by processor(s) 206. The disclosed embodiments are not limited to separate programs or computers configured to perform dedicated tasks. For example, memory 208 may include a single program 210 that performs the functions of cluster system 200, or program(s) 210 may comprise multiple programs. Memory 208 may also store data 212 that is used by program(s) 210. In some embodiments, for example, data 212 may include historical data and/or generated clusters. Other data 212 is possible as well.

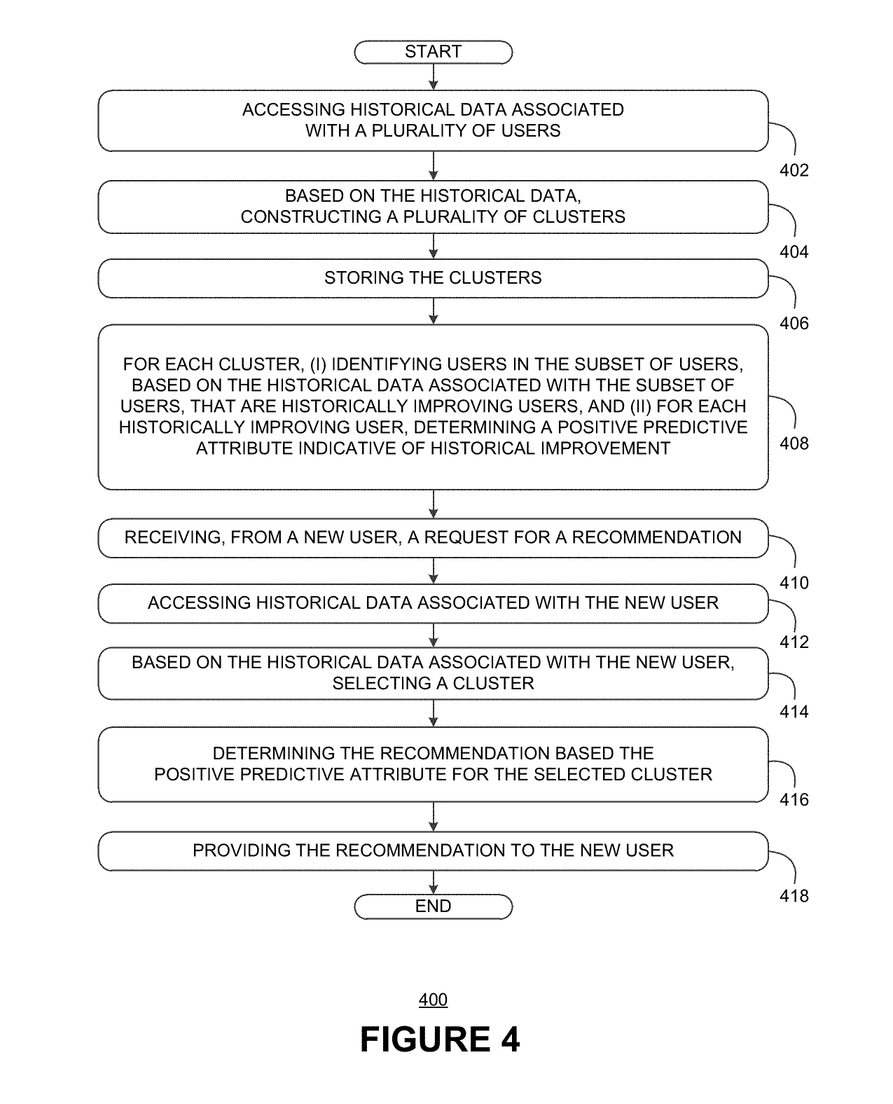

In certain embodiments, memory 208 may store sets of instructions for carrying out the processes described below in connection with FIG. 4. Other instructions are possible as well. In general, instructions may be executed by processor(s) 206 to perform one or more processes consistent with disclosed embodiments.

The components of cluster system 200 may be implemented in hardware, software, or a combination of both hardware and software, as will be apparent to those skilled in the art. For example, although one or more components of cluster system 200 may be implemented as computer processing instructions, all or a portion of the functionality of cluster system 200 may be implemented instead in dedicated electronics hardware.

FIG. 3 is a block diagram of an exemplary computing device 300, consistent with disclosed embodiments. As shown, computing device 300 may include communication device 302, display device 304, processor(s) 306, and memory 308 including program(s) 310 and data 312. Program(s) 310 may include, among others, mobile application 314 and web browser application 316.

In some embodiments, computing device 300 may take the form of a desktop or mobile computing device, such as a desktop computer, laptop computer, smartphone, tablet, or any combination of these components. Alternatively, computing device 300 may be configured as any wearable item, including jewelry, smart glasses, or any other device suitable for carrying or wearing on a customer's person. Other implementations consistent with disclosed embodiments are possible as well. Computing device 300 may, for example, be similar to computing device 102 described above.

Communication device 302 may be configured to communicate with a cluster server, such as cluster servers 104 and 202 described above. For example, communication device 302 may be configured to request and/or receive a recommendation from the cluster server. Communication device 302 may receive such data through, for example, the mobile application 314 and/or web browser application 316.

Communication device 302 may be configured to provide communication over a network, such as network 112 described above. To this end, communication device 302 may include, for example, one or more digital and/or analog devices that allow computing device 300 to communicate with and/or detect other components, such as a network controller and/or wireless adaptor for communicating over the Internet. Other implementations consistent with disclosed embodiments are possible as well.

Display device 304 may be any display device configured to display interfaces on computing device 300. The interfaces may include, for example, web pages provided by computing device 300 through web browser application 316 and/or interfaces provided by computing device 300 through mobile application 314. In some embodiments, display device 304 may include a screen for displaying a graphical and/or text-based user interface, including but not limited to, liquid crystal displays (LCD), light emitting diode (LED) screens, organic light emitting diode (OLED) screens, and other known display devices. In some embodiments, display device 304 may also include one or more digital and/or analog devices that allow a user to interact with computing device 300, such as a touch-sensitive area, keyboard, buttons, or microphones. Other display devices are possible as well. The disclosed embodiments are not limited to any type of display devices otherwise configured to display interfaces.

Processor(s) 306 may include one or more known processing devices, such as a microprocessor from the Core™, Pentium™ or Xeon™ family manufactured by Intel™, the Turion™ family manufactured by AMD™, the “Ax” or “Sx” family manufactured by Apple™, or any of various processors manufactured by Sun Microsystems, for example. Processor(s) 306 may also include various architectures (e.g., x86 processor, ARM®, etc.). The disclosed embodiments are not limited to any type of processor(s) otherwise configured to meet the computing demands required of different components of computing device 300.

Memory 308 may include one or more storage devices configured to store instructions used by processor(s) 306 to perform functions related to disclosed embodiments. For example, memory 308 may be configured with one or more software instructions, such as program(s) 310, that may perform one or more operations when executed by processor(s) 306. The disclosed embodiments are not limited to separate programs or computers configured to perform dedicated tasks. For example, memory 308 may include a single program 310 that performs the functions of computing device 300, or program(s) 310 may comprise multiple programs. Memory 308 may also store data 312 that is used by program(s) 310. Data 312 may include, for example, data associated with computing device(s) and/or with user(s) associated with computing device(s).

In some embodiments, program(s) 310 may include mobile application 314. The mobile application 314 may be executable by processor(s) 306 to perform operations including, for example, requesting a recommendation from a cluster server, such as cluster servers 104 and 202 described above, and/or receiving the recommendation from the cluster server. The mobile application 314 may be executable by processor(s) 306 to perform other operations as well.

In some embodiments, program(s) 310 may further include web browser application 316. The web browser application 316 may be executable by processor(s) 306 to perform operations including, for example, providing web pages for display. The web pages may be provided, for example, via display device 304. In some embodiments, the web pages may be associated with a cluster server, such as cluster servers 104 and 202 described above. Web browser application 316 may be executable by processor(s) 306 to perform other operations as well.

The components of computing device 300 may be implemented in hardware, software, or a combination of both hardware and software, as will be apparent to those skilled in the art. For example, although one or more components of computing device 300 may be implemented as computer processing instructions, all or a portion of the functionality of computing device 300 may be implemented instead in dedicated electronics hardware.

FIG. 4 is a flowchart of an exemplary cluster process 400, consistent with disclosed embodiments. Cluster process 400 may be carried out by a cluster server, such as cluster servers 104 and 202 described above.

As shown in FIG. 4, cluster process 400 includes at step 402 accessing historical data associated with a plurality of users. The historical data may be stored at and/or maintained by the cluster server and/or by one or more other entities, such as a historical data server. In some embodiments, the cluster server may access the historical data periodically, such as at predetermined time intervals. Alternatively or additionally, the cluster server may access the historical data in response to a trigger, such as in response to receiving a request for a recommendation from a new user or in response to detecting that new historical data is available. Still alternatively or additionally, historical data may be pushed to the cluster server periodically and/or as new historical data is available. The cluster server may access the historical data in other manners as well.

The historical data may include data describing a number of users and, for each user, a number of attributes exhibited by the user during a period of time. For example, historical data may include data describing, for each user, financial actions the user has taken over a time period and changes to the user's credit score during the time period.

Example data describing a user's financial actions and/or changes to the user's credit score may include, for instance, a credit history of the user, including the user's credit activity, credit accounts, other financial accounts, credit cards, credit utilization, length of credit, number of credit inquiries, and/or payment history.

At step 404, cluster process 400 includes, based on the historical data, constructing a plurality of clusters. Each cluster may be a portion of the historical data relating to a subset of the users described by the historical data, where the subset of users is limited on the basis of user identity, attributes, and/or time period described by the historical data. That is, each cluster may include historical data relating to only the subset of the users exhibiting a certain attribute or attributes during the time period. For example, for historical data indicating what financial actions users have taken over a time period, along with historical data indicating changes in the users' credit scores during the time period, an example cluster may include historical data relating to only a subset of the users who have taken certain financial actions during a certain time period. Historical data relating to other users who have not taken these financial actions during this time period is not included in the cluster.

In some embodiments, the historical data may be organized into any number of clusters. In some cases, historical data relating to a given user may be included in only a single cluster. Alternatively, historical data relating to a given user may be included in two or more clusters. Historical data organized into clusters may be stored in data storage.

In some embodiments, the clusters may be generated based on a portion, rather than all, of the historical data. For example, in some embodiments, only historical data meeting certain criteria may be relied upon in generating the clusters. For instance, for historical data describing credit histories of users, only historical data for users meeting certain criteria (e.g., having a non-zero credit score or a credit score within a certain range, having a credit history of a sufficient length, or not having a freeze on a financial account associated with the user) may be used to generate the clusters, and other historical data may be filtered out by the cluster server. Alternatively or additionally, in some embodiments the historical data may be “sanitized” before the clusters are generated. Sanitizing the data may involve, for example, assigning representative numeric equivalents to any null values in the historical data. Still alternatively or additionally, in some embodiments the historical data may be filtered to remove historical data describing users having no change in one or more attributes over the time period described by the historical data. For example, for historical data describing changes in users' credit scores of a time period, historical data describing a user whose credit score remains unchanged over the time period may be filtered out prior to clustering.

In some embodiments, because a cluster relates to only a subset of users that is limited on the basis of user identity, attributes, and/or time period described by the historical data, the subset of users associated with the historical data in the cluster may exhibit similarities to one another. For example, for historical data describing financial actions taken by users over a time period, along with historical data indicating changes in the users' credit scores during the time period, users in a cluster defined by users' incomes, payment histories, and/or credit utilization may exhibit similar financial situations or financial goals.

In some embodiments, clustering the users may involve a k-means clustering algorithm. K-means clustering is a method of vector quantization that aims to cluster observations (e.g., users) into clusters such that each observation (e.g., user) belongs to the cluster having the nearest mean with respect to a specific attribute. In k-means clustering, the clusters are initially estimated and each observation is assigned to a cluster. Thereafter, the clusters are iteratively redefined, and the observations iteratively reassigned, until further redefining of the clusters no longer causes any observations to be reassigned.

For purposes of illustration, observations having two attributes (e.g, attribute A and attribute B) may be considered. Each observation could be plotted on a coordinate system (e.g., a Cartesian coordinate system) having attribute A along one dimension (e.g., a horizontal axis) and attribute B along another dimension (e.g., a vertical axis). The k-means clustering algorithm could cluster the observations into one of a number (e.g., n) of clusters, with each cluster filling a contiguous region in the coordinate system. Thereafter, the clusters may be iteratively redefined within the coordinate system, and the observations iteratively reassigned to the clusters, until further redefining of the clusters no longer causes any observations to be reassigned. While the foregoing illustration focused on observations having two attributes, the same principles of plotting the observations in a coordinate system and defining clusters as contiguous regions in the coordinate system could apply to observations having three or more attributes, with the observations being plotted in a coordinate system having three or more dimensions.

Other clustering algorithms are possible as well, including, for instance, hierarchical agglomerative clustering, in which hierarchies of clusters are formed; density-based spatial clustering of applications with noise (“DBSCAN”), in which observations that are closely packed in a coordinate system are grouped into a cluster and isolated observations are treated as outliers; and spectral clustering, in which eigenvalues of a similarity matrix of the observations are used to reduce the dimensionality (i.e., number of attributes) of the observations before clustering.

Cluster process 400 further includes, at step 406, storing the clusters. In some embodiments, the clusters may be stored at the cluster server. Alternatively or additionally, the clusters may be stored in data storage, such as data storage 110 described above, accessible by the cluster server. Data storage may take the form of, for example, a database and/or cloud-based storage.

Cluster process 400 further includes, at step 408, for each cluster in the plurality of clusters, identifying users in the subset of users, based on the historical data associated with the subset of users, that are historically improving users. To this end, the cluster server may be configured to calculate a change in at least one attribute for each user in the subset of users. That is, the cluster server may determine for each user, based on the historical data describing the user, how an attribute has changed over a time period. Based on the change, the cluster server may classify the user as historically improving or historically declining. For example, for historical data describing credit histories of users, the cluster server may calculate a change in credit score for each user and classify those users whose credit scores have increased as historically improving and those whose credit scores have decreased as historically declining.

Cluster process 400 may further include, also at step 408 for each cluster in the plurality of clusters, determining, for each historically improving user, a positive predictive attribute indicative of historical improvement. In some embodiments, more than one positive predictive attribute may be determined as well. Alternatively or additionally, in some embodiments cluster process 400 may further include determining, for each historically declining user, one or more negative predictive attributes indicative of historical decline.

Determining the positive predictive attribute(s) and/or negative predictive attribute(s) may involve, for example, using a feature selection algorithm (e.g, a Chi-squared algorithm) to rank attributes described by the historical data according to their predictive power. For example, for historical data describing credit histories of users, the cluster server may determine, for users whose credit scores have decreased, the attribute(s) most predictive of a decreasing credit score, and select some or all of those attribute(s) as the predictive attribute(s) indicative of historical decline. Similarly, the cluster server may determine, for users whose credit scores have increased, the attribute(s) most predictive of an increasing credit score, and select some or all of those attribute(s) as the positive predictive attribute(s) indicative of historical improvement.

Alternatively or additionally, determining each of the negative predictive attribute(s) and the positive predictive attribute(s) may involve identifying changes in the subset of users' activity that have had the largest impact. For example, for historical data describing credit histories of users, the cluster server may determine, for users whose credit scores have decreased, the financial activities that have most impacted a decreasing credit score, and select some or all of those financial activities as the negative predictive attribute(s) indicative of historical decline. Similarly, the cluster server may determine, for users whose credit scores have increased, the activities that have most impacted an increasing credit score, and select some or all of those activities as the positive predictive attribute(s) indicative of historical improvement.

In some embodiments, the cluster server may select as the negative or positive predictive attributes a predetermined number of attributes (e.g., the n most predictive attributes of decline and of improvement) and/or attributes having predictive power above a certain threshold.

Cluster process 400 further includes, at step 410, receiving, from a new user, a request for a recommendation. The request may be received from, for example, a computing device associated with the new user, such as computing device 102 associated with user 118. In some embodiments, the request may be received via one or both of a mobile application executed at the computing device associated with the new user and/or a web page provided by a web browser application executed at the computing device associated with the new user. In some embodiments, the request may identify the user and/or the computing device.

At step 412, the cluster server may access historical data associated with the new user. The historical data associated with the new user may describe, for example, a number of attributes exhibited by the new user during a period of time. For example, the historical data may be data describing financial actions the new user has taken over a time period and changes to the new user's credit score during the time period. For example, where the new user requests a recommendation for improving the new user's credit score, the historical data associated with the new user may include a credit history of the new user, changes to the new user's credit score, the new user's financial situation, and/or the new user's payment history over the time period.

Cluster process 400 further includes, at step 414, based on the historical data associated with the new user, selecting a cluster from the plurality of clusters. Selecting the cluster may involve selecting the cluster having a subset of users that are most similar to the new user. As noted above, in some embodiments, because a cluster includes only a subset of users that is limited on the basis of the user, attributes, and/or time period described by the historical data, the subset of users included in the cluster may exhibit similarities to one another. For example, for historical data describing financial actions taken by users over a time period, along with historical data indicating changes in the users' credit scores during the time period, users in a cluster that is limited on the basis of the users' incomes, payment histories, and/or credit utilization may exhibit similar financial situations or financial goals. Selecting a cluster based on the historical data of the new user may, for instance, involve selecting the cluster that includes the subset of users most similar to the new user. For example, the selected cluster may include a subset of users that exhibit similar financial situations or financial goals to the new user.

Once a cluster is selected, cluster process 400 includes, at step 416, determining the recommendation based on the positive predictive attribute(s) for the selected cluster. In some embodiments, the recommendation may be alternatively or additionally determined based on the negative predictive attribute(s) for the selected cluster. By selecting a cluster comparable to the new user, the cluster server may generate a recommendation that is tailored to the new user. For example, where the new user requests a recommendation for improving the new user's credit score, by selecting a cluster having users exhibiting similar financial situations or financial goals to the new user, the cluster server may generate a recommendation that is most likely to impact the new user's credit score and be achievable by the new user.

In some embodiments, the recommendation may recommend that the new user adopt the positive predictive attribute(s). For example, where the new user requests a recommendation for improving the new user's credit score, the recommendation may recommend that the new user adopt the attribute(s) most predictive of an increasing credit score and/or the activities most likely to increase a credit score for the subset of users in the selected cluster. Because the subset of users in the selected cluster are comparable to the new user, adopting the recommended attribute(s) and/or activities may be more likely to similarly benefit the new user and may be more likely achievable by the new user.

Alternatively or additionally, in some embodiments, the recommendation may recommend that the new user avoid the negative predictive attribute(s). For example, where the new user requests a recommendation for improving the new user's credit score, the recommendation may recommend that the new user avoid the attribute(s) most predictive of a decreasing credit score and/or the activities most likely to decrease a credit score for the subset of users in the selected cluster. Because the subset of users in the selected cluster are comparable to the new user, avoiding the recommended attribute(s) and/or activities may be more likely to benefit the new user and may be more likely achievable by the new user.

In some embodiments, the cluster server may determine the recommendation in response to receiving the request for the recommendation from the new user. Alternatively, in some embodiments, the recommendation may be determined along with generation of the clusters and stored alongside the generated clusters. In these embodiments, determining the recommendation may involve accessing the stored recommendation determined for the selected cluster.

The cluster process 400 further includes, at step 418, providing the recommendation to the new user. The cluster server may provide the recommendation to, for example, a computing device associated with the new user, such as computing device 102 associated with user 118. In some embodiments, the recommendation may be provided via one or both of a mobile application executed at the computing device associated with the new user and/or a web page provided by a web browser application executed at the computing device associated with the new user.

In some embodiments, cluster process 400 may further involve, once the recommendation has been provided, collecting data indicative of whether the new user implemented the recommendation. Such data may indicate, for example, whether the recommendation was achievable by the new user. In some embodiments, this data may be aggregated with the historical data used to generate the clusters, such that the clusters better reflect which positive predictive attributes are achievable for certain subsets of users and which negative predictive attributes are avoidable for certain subsets of users.

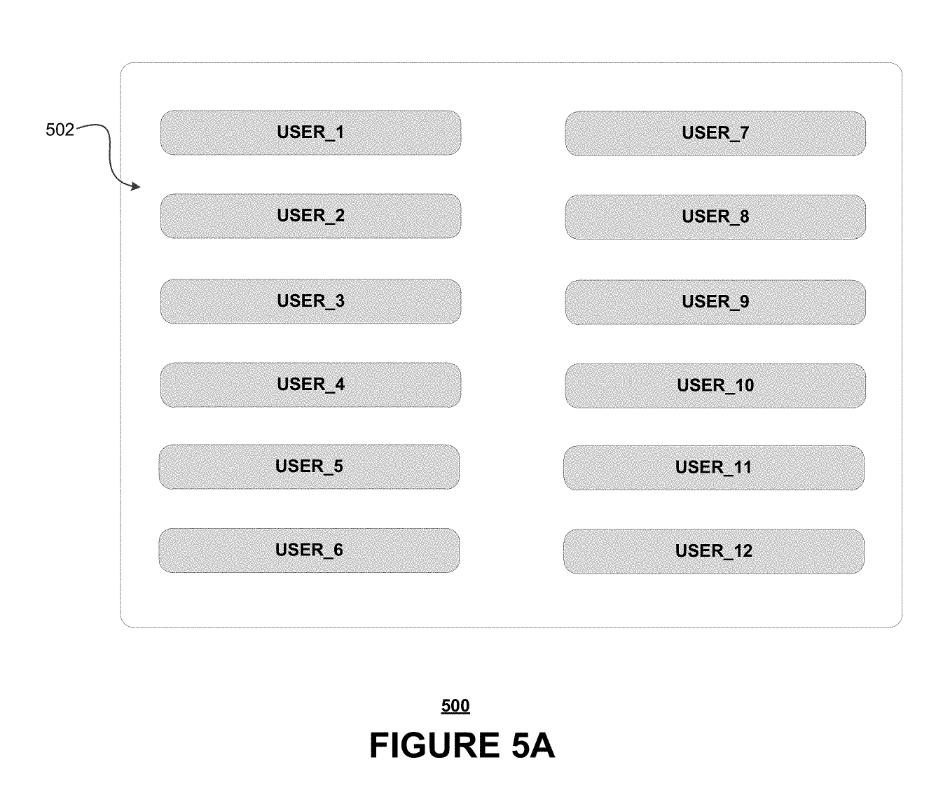

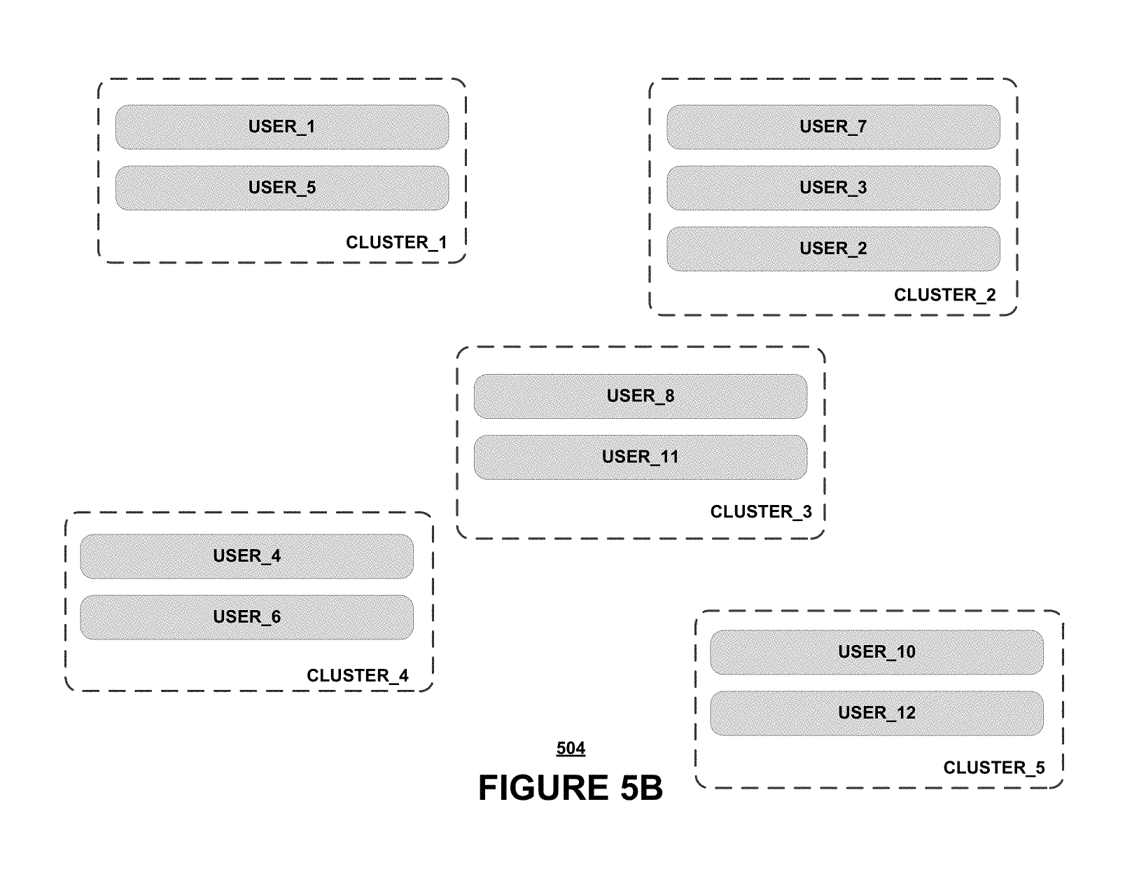

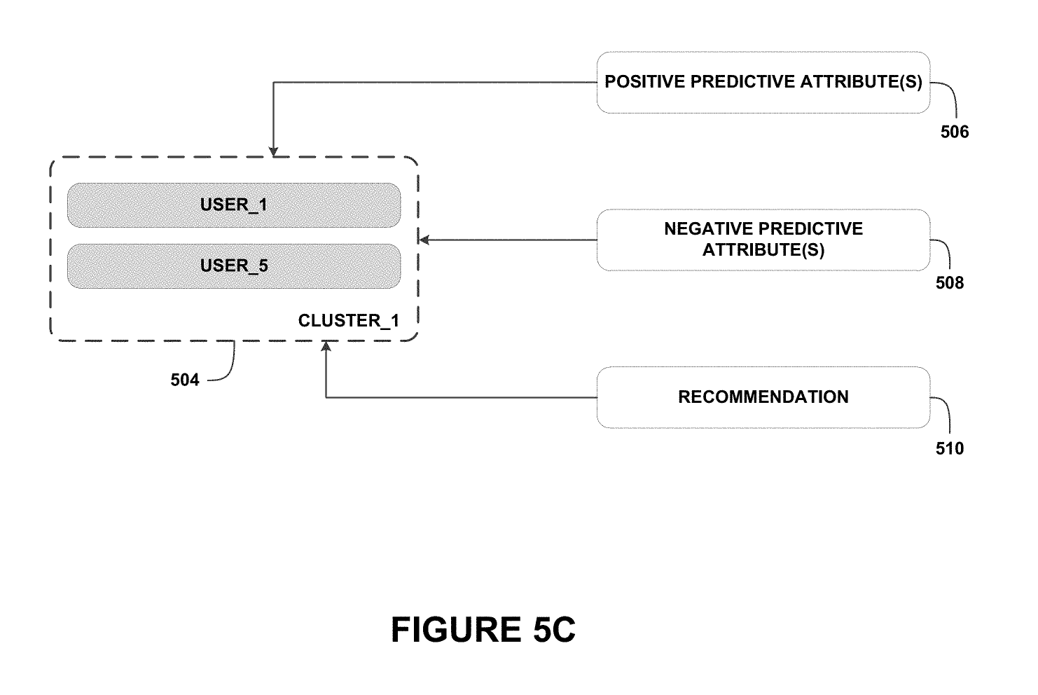

FIGS. 5A-5C illustrate exemplary clustering of historical data 500, consistent with disclosed embodiments. As shown in FIG. 5A, historical data 500 may include data relating to a number of users 502 (“USER_1,” “USER_2,” etc.). More or fewer users 502 are possible. Each user may be an individual, an entity, or an account associated with an individual or an entity.

For each user 502, historical data 500 may include a number of attributes exhibited by the user 502 during a period of time. For example, for “USER_1” historical data 500 may describe financial actions “USER_1” has taken over a time period and changes to “USER_1”'s credit score during the time period.

Alternatively or additionally, while historical data 500 is shown to be organized by user 502, in some embodiments historical data 500 may be organized by one or more other features of historical data 500, such as attribute(s), time period, name, date, file size, and/or other feature.

As described above, a cluster server may be configured to access historical data 500 and generate a plurality of clusters based on historical data 500. Example clusters 504 are shown in FIG. 5B. Each of the clusters 504 may include a portion of historical data 500 relating to a subset of users 502, where the subset is defined on the basis of user identity, attributes, and/or a specific time period. That is, each cluster 504 may include historical data 500 relating to only a subset of users 502 exhibiting a certain attribute or attributes during a time period. For example, “CLUSTER_1” may include a portion of historical data 500 relating to a subset of users 502, namely, “USER_1” and “USER_5.” This subset may be defined to include only data of users who have taken certain financial actions during a certain time period. Historical data 500 relating to other users 502 who have not taken these financial actions during this time period is not included in “CLUSTER_1.” Historical data 500, once clustered into clusters 504, may be stored in data storage, such as a database and/or cloud-based storage.

In some embodiments, the clusters 504 may be generated based on only some, rather than all, of historical data 500. For example, in some embodiments, only historical data 500 meeting certain criteria may be relied upon in generating the clusters. As shown, for instance, historical data 500 relating to “USER_9,” may be filtered out prior to generating the clusters 504 if “USER_9” fails to meet some criteria. For instance, “USER_9” may have too short of a credit history. Alternatively or additionally, “USER_9” may have a static credit score over the time period.

Referring now to FIG. 5C, for each cluster 504, at least one positive predictive attribute 506 and at least one negative predictive attribute 508 may be determined. For “CLUSTER_1,” for example, the cluster server may determine which users in “CLUSTER_1” have historically improved (e.g., whose credit scores have increased) and which have historically declined (e.g., whose credit scores have decreased). The cluster server may determine, for users whose credit scores have increased, the attribute(s) (e.g., financial activities) most predictive of an increasing credit score, and select some or all of those attribute(s) as the at least one positive predictive attribute 506 indicative of historical improvement, as described above. Similarly, the cluster server may further determine, for users in “CLUSTER_1” whose credit scores have decreased, the attribute(s) (e.g., financial activities) most predictive of a decreasing credit score, and select some or all of those attribute(s) as the at least one negative predictive attribute 508 indicative of historical decline, as described above. The positive predictive attribute(s) 506 and the negative predictive attribute(s) 508 may, for example, be stored in data storage in association with the “CLUSTER_1,” as shown in FIG. 5C.

The cluster server may be further configured to determine a recommendation 510, either upon generating the clusters 500 or upon receiving a request for a recommendation from a new user. The recommendation 510 may include data indicating some or all of the positive predictive attribute(s) 506 and the negative predictive attribute(s) 508, as described above. The recommendation 510 may be stored in data storage in association with the “CLUSTER_1” as well, as shown in FIG. 5C.

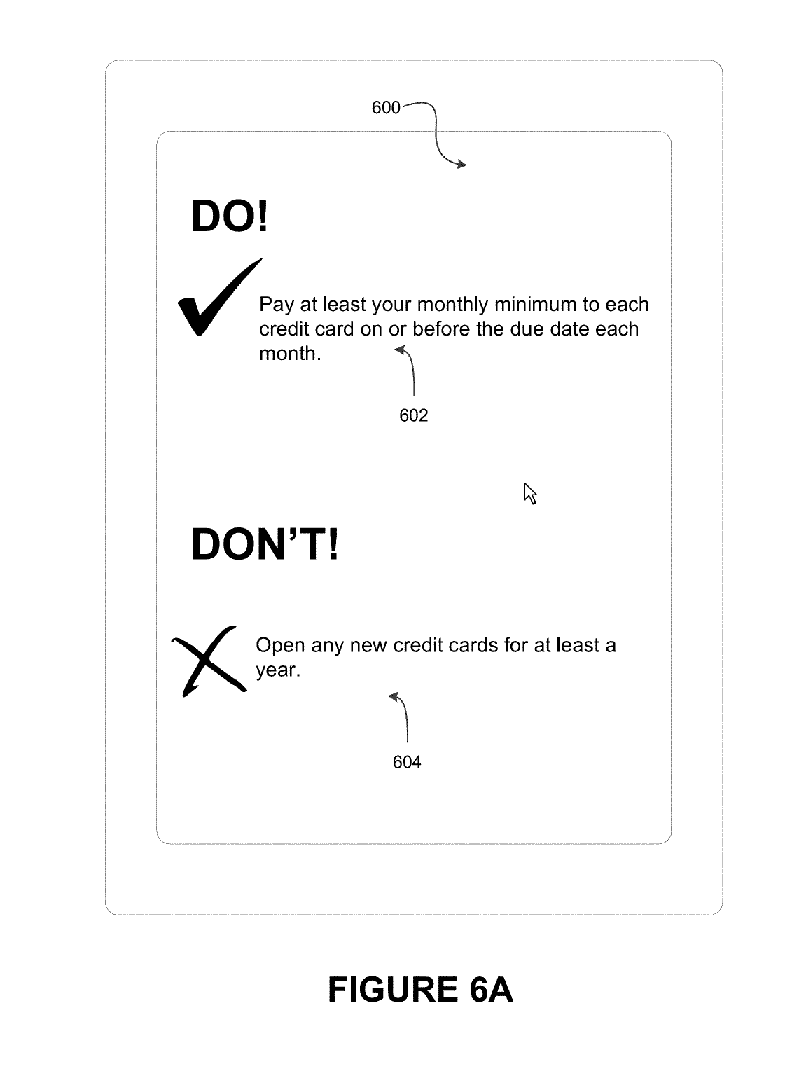

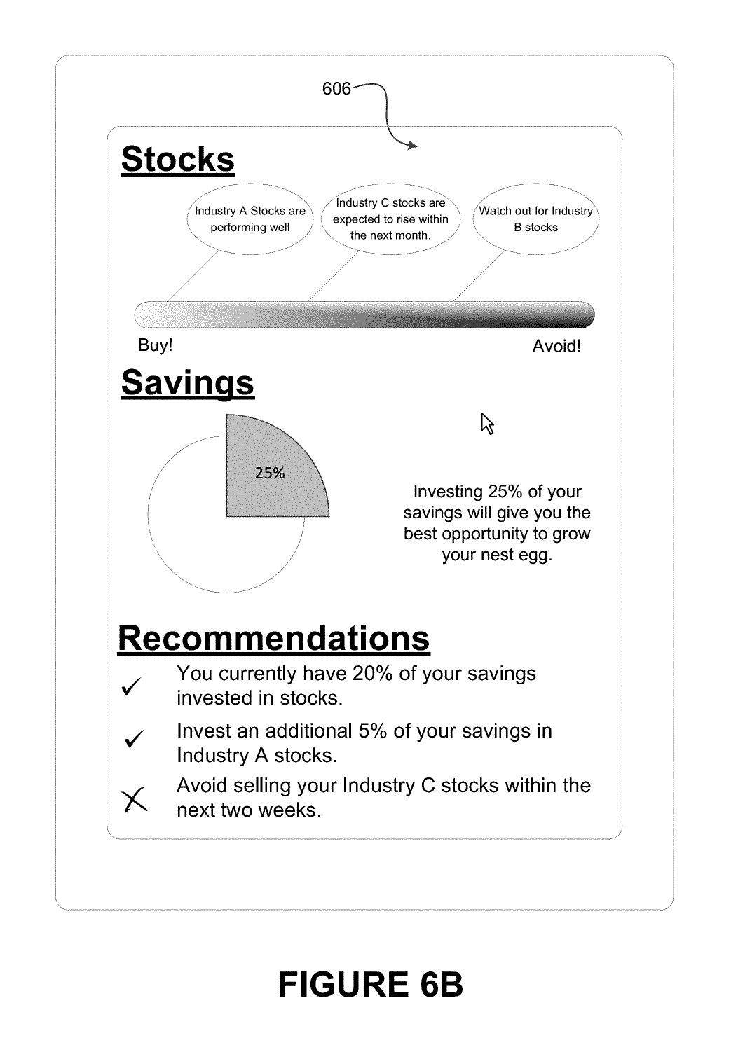

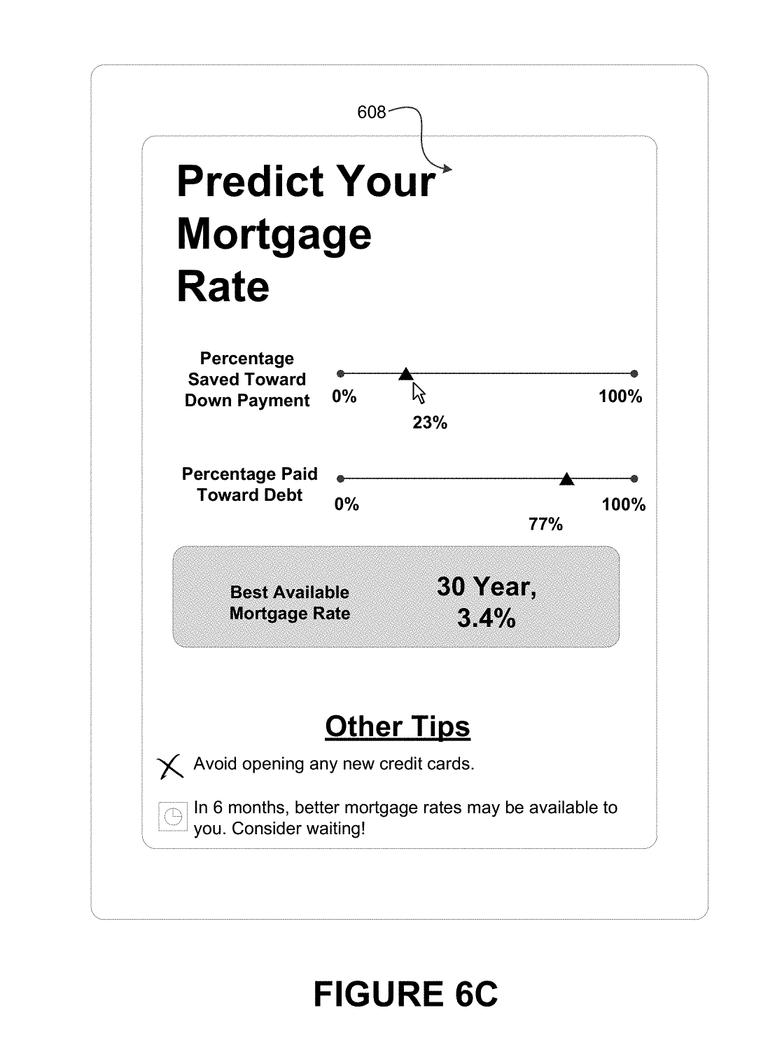

FIGS. 6A-6C illustrate exemplary recommendations provided to a new user, consistent with disclosed embodiments. Recommendations may be data indicating attributes that will assist the new user in achieving a desired outcome and/or attributes that will hinder a user in achieving a desired outcome.

FIG. 6A illustrates an example recommendation 600 for improving a new user's credit score. As shown, the recommendation 600 may recommend that the new user emulate certain positive predictive attributes 602 associated with a selected cluster, as described above. For instance, as shown, the recommendation 600 may indicate that the new user should pay his or her credit card bill on time. Alternatively or additionally, the recommendation 600 may recommend that a user avoid certain negative predictive attributes 604 associated with the selected cluster, as shown above. For instance, as shown, the recommendation 600 may indicate that the new user should avoid opening new credit cards. While a certain number of positive and negative attributes are shown, it will be understood that more or fewer positive and/or negative attributes are possible as well.

FIG. 6B illustrates an example recommendation 606 for creating or managing a stock portfolio. As shown, the recommendation 606 may recommend that the user engage in or avoid particular actions indicative of positive and/or negative predictive attributes associated with a selected cluster, as described above. For instance, if positive predictive attributes associated with the selected cluster indicate that users have benefitted from using only a certain percentage of savings to purchase stocks and/or from purchasing stocks of a certain type, the recommendation 606 may recommend that the new user use a certain percentage of savings to purchase stocks of a certain type. As another example, if negative predictive attributes associated with the selected cluster indicates that users have been harmed by selling certain stocks and/or selling stocks within a certain time period, the recommendation 606 may recommend that the new user avoid selling a certain stock within a certain time period.

FIG. 6C illustrates an example recommendation 608 for preparing to apply for a mortgage. As shown, the recommendation 608 may indicate to the new user how certain actions will impact mortgage interest rates available to the user. The impact may be determined based on, for example, positive and/or negative predictive attributes associated with a selected cluster, as described above. For instance, if positive predictive attributes associated with the selected cluster indicate that mortgage interest rates are lower for users who have more money in savings and/or have had a credit card for more than a certain period of time, the recommendation 608 may indicate that increasing savings and/or waiting a certain period of time may result in improved interest rates being available to the new user. As another example, if negative predictive attributes associated with the selected cluster indicate that mortgage interest rates are higher for users who have certain types of debt above a certain threshold and/or who have a debt-to-savings ratio above a certain threshold, the recommendation 608 may recommend that the new user decrease certain types of debt and/or save certain amounts of money each month. In some embodiments, the recommendation 608 may recommend certain actions to the new user based on a combination of the positive and negative of predictive attributes. For example, the recommendation 608 may indicate to the user how available mortgage rates may change based on changes in savings and/or debt repayment.

It will be understood that recommendations 600, 606, and 608 are merely illustrative and are not meant to be limiting. That is, other recommendations based on other positive and/or negative predictive attributes are possible as well. The presentations of the recommendations 600, 606, and 608 are similarly illustrative and not meant to be limiting. Other presentations of the recommendations are possible as well.

In some examples, some or all of the logic for the above-described techniques may be implemented as a computer program or application or as a plug-in module or subcomponent of another application. The described techniques may be varied and are not limited to the examples or descriptions provided.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments. For example, while a financial service provider and merchant have been referred to herein for ease of discussion, it is to be understood that consistent with disclosed embodiments other entities may provide such services in conjunction with or separate from a financial service provider and merchant.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects may also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

1. A server comprising:
a memory storing instructions; and
a processor configured to execute the instructions to perform operations comprising:
accessing historical data associated with a plurality of users;
based on the historical data, constructing a plurality of clusters, wherein constructing each cluster comprises:
selecting a subset of comparable users, and
including in the cluster historical data associated with the subset of comparable users;
storing the clusters;
receiving, from a new user, a request for a recommendation;
accessing historical data associated with the new user;
based on the historical data associated with the new user, selecting a cluster for which the subset of comparable users is comparable to the new user;
based on the selected cluster, determining a recommendation; and
providing the recommendation to the new user.

2. The server of claim 1, wherein the request indicates a financial goal of the new user.

3. The server of claim 2, wherein the subset of comparable users being comparable to the new user comprises the subset of comparable users exhibiting financial goals similar to the financial goal of the new user.

4. The server of claim 2, wherein the recommendation indicates how the new user can achieve the financial goal.

5. The server of claim 1, wherein the request indicates a financial situation of the new user.

6. The server of claim 5, wherein the subset of comparable users being comparable to the new user comprises the subset of comparable users exhibiting financial situations similar to the financial situation of the new user.

7. The server of claim 5, wherein the recommendation indicates how the new user can improve the financial situation.

8. The server of claim 1, wherein the request indicates a credit history of the new user.

9. The server of claim 8, wherein the subset of comparable users being comparable to the new user comprises the subset of comparable users exhibiting credit histories similar to the credit history of the new user.

10. The server of claim 8, wherein the recommendation indicates how the new user can improve the credit history.

11. The server of claim 1, wherein determining the recommendation comprises:
identifying users in the subset of comparable users, based on the historical data associated with the subset of comparable users, that are historically improving users, and
for each historically improving user, determining, based on the historical data associated with the historically improving user, a positive predictive attribute indicative of historical improvement.

12. The server of claim 11, wherein the recommendation comprises an indication of the positive predictive attribute.

13. The server of claim 1, wherein determining the recommendation comprises:
identifying users in the subset of comparable users, based on the historical data associated with the subset of comparable users, that are historically declining users, and
for each historically declining user, determining, based on the historical data associated with the historically declining user, a negative predictive attribute indicative of historical decline.

14. The server of claim 13, wherein the recommendation comprises an indication of the negative predictive attribute.

15. The server of claim 1, the operations further comprising collecting data indicative of whether the new user implemented the recommendation.

16. The server of claim 1, wherein storing the clusters comprises storing the clusters in one of a database and cloud-based storage.

17. The server of claim 1, wherein receiving the request from the new user comprises receiving the request from a device associated with the new user.

18. The server of claim 17, wherein receiving the request from the device associated with the new user comprises receiving the request via a mobile application executed at the device associated with the new user.

19. The server of claim 17, wherein receiving the request from the device associated with the new user comprises receiving the request via a web browser application executed at the device associated with the new user.

20. The server of claim 17, wherein providing the recommendation comprises providing the recommendation to the device associated with the new user.
